(19) United States
(12) Patent Application Publication
(10) Pub. No.: US 2012/0193292 A1
(43) Pub. Date: Aug. 2, 2012

(54) RETICULATED LIQUID TREATMENT DEVICES WITH ELECTRIC POWER SOURCE

(75) Inventors: Primo L. Acernese, Allentown, PA (US); James Novak, JR., Emmaus, PA (US); Thomas Lotts, Austin, TX (US); William J. Parkinson, Bethlehem, PA (US)

(73) Assignee: TerraGroup Corporation, Allentown, PA (US)

(21) Appl. No.: 13/445,544

(22) Filed: Apr. 12, 2012

Related U.S. Application Data
(63) Continuation of application No. 11/045,555, filed on Jan. 28, 2005, now abandoned.

(51) Int. Cl. C02F 1/46; C02F 1/42

(52) U.S. Cl. 210/660; 210/243; 210/748.16; 210/748.01

(57) ABSTRACT

The present invention relates to devices for treating liquids, and methods for treating liquids, particularly by using such devices. Reticulated electrode structures with a high proportion of surface area to volume are formed with at least two metals, and are coupled in arrays to an electrical driving signal such as an alternating and/or direct current voltage source, for ion exchange with a liquid to be treated, to produce, e.g., potable water.

### CROSS REFERENCE TO RELATED APPLICATION

This application is a continuation of U.S. Ser. No. 11/045,555, filed Jan. 28, 2005.

### FIELD OF THE INVENTION

The present invention relates to devices for treating liquids, and methods for treating liquids, particularly by using such devices. Reticulated electrode structures with a high proportion of surface area to volume are formed with at least two metals, and are coupled in arrays to an electrical driving signal such as an alternating current or direct current voltage source, for e.g., ion exchange, electron transfer, galvanic absorption, etc. with a liquid to be treated, to produce, e.g., potable water.

### BACKGROUND OF THE INVENTION

Water is of course needed for any number of uses, such as general household, industrial, military and medical applications. The water may be obtained from a source in which the water is aptly purified prior to use. It may also be advisable to purify used or “gray” water before discharging it into the environment. Purification may include removing from the water (or reducing the proportionate content thereof) undesired biological and/or chemical entities, or neutralizing or counteracting the activity or detrimental effects of such materials. Any number of materials may be involved, such as microorganisms, including bacteria, protozoans, or viruses; algae; noxious chemicals; radioactive material; or heavy metals.

Typical methods of purification may include chemical treatment, such as treatment with oxidizing agents (e.g, chlorine) or other reagents intended to precipitate or neutralize harmful components; application of electromagnetic energy (e.g., ultraviolet light) as a biocidal step; sedimentation of solids that are entrained or precipitated; filtration through particle and/or reverse osmosis filter media; application to surface active agents or passage over surface absorption elements of activated carbon or the like; or ion exchange.

A common chemical treatment includes combining water with one or more compounds containing chlorine. Chlorine is useful in controlling bacteria and is often used in the form of hypochlorous acid or calcium hypochlorite. However, chlorine (Cl₂) can damage purification elements such as reverse osmosis filters, and discharge of chlorinated water raises environmental concerns. Other chemical compounds that have been used for treatment of water, particularly for removal of organic compounds, include potassium permanganate and sodium hydroxide.

Reverse osmosis generally uses a filtration membrane, which allows a liquid such as water to pass through while partially or completely retaining species such as salts. Flow across the membrane is driven by a chemical potential gradient; generally, osmosis relies on a gradient from high concentration to low concentration. In reverse osmosis, a “reverse” gradient can be formed, e.g., by the application of an external driving force such as pressure or mechanical means. Membranes used in osmosis can have a chemical charge, imparted by the presence of functional groups such as carboxylic or sulfonic groups on the membrane. Charged membranes that can allow relatively high liquid flux and can remove compounds such as organic materials and color agents are used in modern filtration techniques, such as nanofiltration.

Precipitants and coagulants are also known for use in water treatment and purification, and can be used in combination with other agents. An exemplary water purification composition is disclosed in U.S. Pat. No. 5,681,475, hereby incorporated by reference. This patent discloses a composition provided in unit-dosage form, including a disinfectant-sanitizer; a coagulant precipitant; a dispersion-buffer agent; a primary colloidal flocculant; a secondary colloidal flocculant; an agglomeration matrix and pre-filter; and a bulk ion exchange absorbent.

It may be desirable or necessary to remove heavy metals from a water supply. Metals in water supplies or wastewater may include, for example, copper, chromium, zinc, cadmium, mercury, lead and nickel. Metals and other similar contaminants may be removable by chemical precipitation as carbonates, hydroxides or sulfides, or by activated carbon, reverse osmosis, ion exchange and other known techniques.

On the other hand, certain metal ions are known to be active as algaecides, bactericides, etc., and some metals may be useful as reagents that bind with chlorine or other halogen water treatment agents. Metal particulate or metal powder elements are used for water treatment, and may be placed serially in a water flow so as to interact with a flow of water. Typical metals used in particulate form for water purification include zinc and copper, which are useful for treating water containing chlorine and bacteria, respectively. U.S. Pat. No. 5,314,623, incorporated herein by reference, discloses a method for treating fluids that utilizes a bed of metal particles such as aluminum, steel, zinc, tin, copper, and mixtures and alloys thereof. The preferred metals are zinc and copper, which can be combined in the form of an alloy such as brass, to which the water is exposed.

A need remains for improvements and new effective treatment methods and devices for water and other liquids. A particular benefit could be obtained by improving methods and devices that can effectively remove bacteria and/or heavy metals. The present invention is directed toward these and other important ends.

### SUMMARY OF THE INVENTION

One aspect of the invention is a device for treating liquids which includes a reticulated element or structure formed from at least two metals, one of which metals preferably is silver. The metals are preferably in the form of an alloy, and although integral are caused by reticulation to have a porous or foamed shape characterized by a high proportion of surface area to volume. The device has two or more electrically isolated portions that are held at a potential difference by an electric power supply. Isolation can be provided, for example, by interspersing a non-conducting material between the reticulated structures to which electrical power is applied. The power supply is preferably a moderate direct current voltage source, but it is also possible to employ time varying signals or polarity reversal, etc., such as alternating current.

In embodiments, the reticulated structures or elements are disc-shaped. The disc-shaped reticulated structures can be stacked and carried in a housing that defines a flow path for water over the elements. For example, a number of reticulated metal discs can be stacked in series in the housing, with the water flowing through the reticulated bodies of the discs. In certain embodiments, two or more of the reticulated structures are in direct contact with one another, whereby they are electrically connected. In other embodiments, two or more of the reticulated structures are spaced apart from each other or stacked on an “interleaved” insulator, such that they do not come into direct contact with one another and can be coupled respectively to the anode and cathode leads of the power supply. Alternatively, one or more elements can be held at a given potential or driven at a predetermined time varying voltage relative to another reference, such as a metallic portion of the housing to which the water is exposed.

Another aspect of the invention is a method for reducing the apparent hardness of a liquid. The method includes treating the liquid by contacting the liquid with a device comprising two or more reticulated structures coupled to anode and cathode leads of an electrical power supply. The reticulated structures may be spaced apart from each other or stacked on an interleaved insulator, such that they do not come into direct contact with one another. In other embodiments, a plurality of reticulated structures having the same charge, i.e. anode or cathode, are stacked in contact with one another, and are separated by an insulating material from one or more reticulated structures having the opposite charge.

In embodiments, one or more discs made of a non-metallic material may be included. Such non-metallic discs may be located so that a first non-metallic disc contacts a reticulated disc coupled to the anode and a second non-metallic disc contacts a reticulated disc coupled to the cathode. One or more additional reticulated discs may be disposed between the first and the second non-metallic discs.

These and other aspects of the present invention will be apparent to one skilled in the art in view of the following disclosure and the appended claims.

### BRIEF DESCRIPTION OF THE DRAWINGS

FIG. 1(a) shows a device for treating liquid, which includes reticulated discs and a pair of electrodes;

FIG. 1(b) shows a device for treating liquid, which includes reticulated discs in direct contact and a pair of electrodes;

FIG. 2(a) shows a device for treating liquid, which includes a plurality of reticulated discs having a positive charge and a single reticulated disc having a negative charge, wherein the positively charged discs and the negatively charged disc are isolated from one another by a non-conducting disc of insulating material;

FIG. 2(b) shows a device for treating liquid, which includes a plurality of reticulated discs having a negative charge and a single reticulated disc having a positive charge, wherein the negatively charged discs and the positively charged disc are isolated from one another by a non-conducting disc of insulating material; and

FIG. 3 shows a device for treating liquid, which includes a single reticulated disc having a positive charge, a single reticulated disc having a negative charge, and two non-conducting discs made of a plastic or ceramic material.

### DETAILED DESCRIPTION OF THE INVENTION

The methods and devices disclosed herein utilize the application of electric power and ion release/deposition elements in the treatment of liquids such as water, and in particular relate to coupling a direct or alternating current to respective reticulated metal elements placed in contact with a flow of water.

The term “treatment,” as used herein to refer to the use of the devices and methods of the present invention, means contacting a liquid with a device as described, in order to reduce, remove, inactivate, neutralize, kill, react, modify, adjust or otherwise affect chemical and/or biological entities in the liquid. This may be accomplished with a raw liquid or a liquid that has been subjected to additives or previous treatment steps, or a liquid that is yet to be subjected to further additives or steps. Generally, the idea is to ameliorate undesirable agents in the liquid, and treatment can therefore include purification. However, it is to be understood that treatment in accordance with this disclosure is not limited to purification or total or partial removal of one or more chemical and/or biological entities, and that other results are within the scope of the invention.

Liquid treatment devices that utilize reticulated metal structures are described in U.S. Pat. Nos. 6,395,168, 5,972,216 and 5,788,858. The disclosures of these documents are hereby incorporated by reference. The metals used in the devices and methods disclosed in the '168 patent can include silver and at least two other metals. In some embodiments, a metal oxide can be used in place of one of the three or more metals.

In accordance with the present invention, it has been found that driving two or more reticulated elements as electrodes (or a single element versus a casing or other reference) with an electric driving current, can enhance the performance of the reticulated elements in connection with treatment of a liquid. The driving signal can be a direct or alternating current potential difference. Current between the driven elements (or the element and the opposed electrode in the circuit) is generally characterized by the release (dissolution) or deposition (plating) of metal ions and other elements and compositions, from or onto the surfaces of the reticulated metal structures to which the liquid is exposed in the treatment, which can enhance the performance of the reticulated metal structures.

The devices of the present invention include one or more reticulated structures made of at least two metals. One of the metals can be silver. Silver is desirable in the devices of the present invention because of its known bactericidal properties. Other metals are also suitable, including copper, zinc, tin, nickel, aluminum, magnesium, vanadium, cobalt, molybdenum, titanium, gold, manganese, platinum, palladium, tungsten, rhenium, and tantalum. The particular composition chosen can be due in part to the physical and chemical properties of the liquid to be treated, the amount of driving voltage to be applied, and other factors consistent with this disclosure.

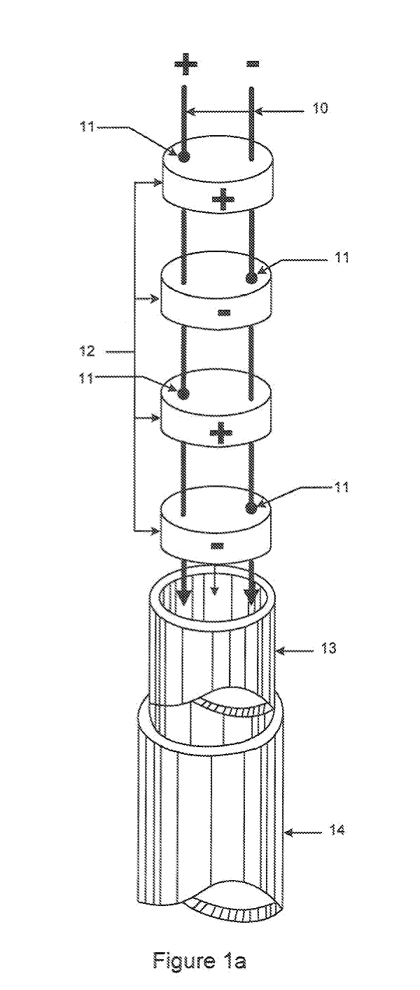

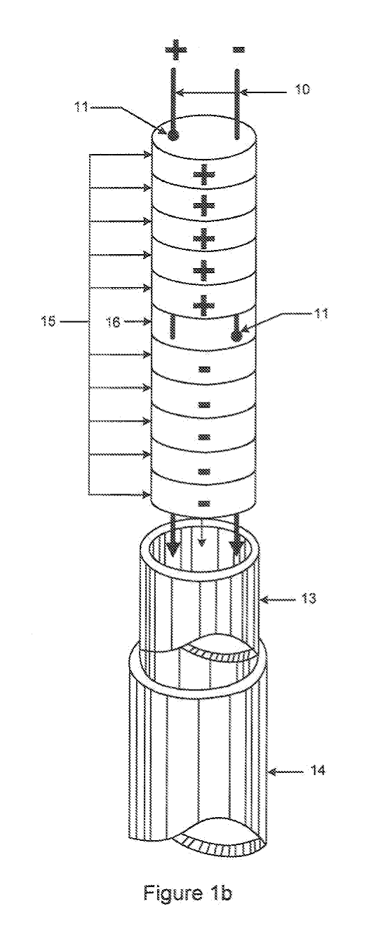

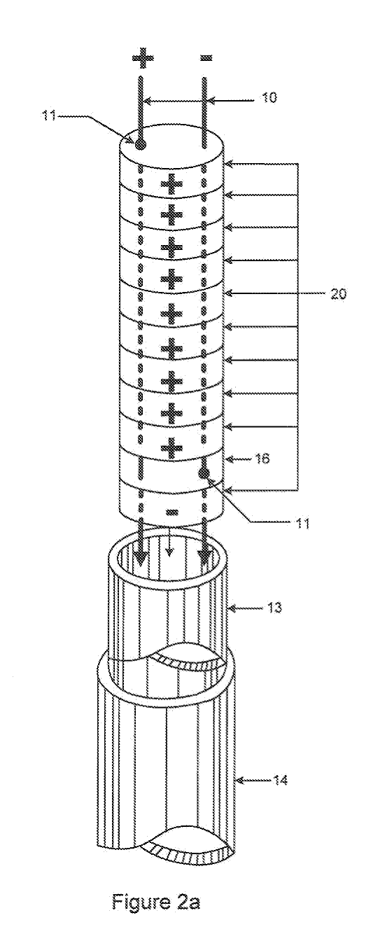

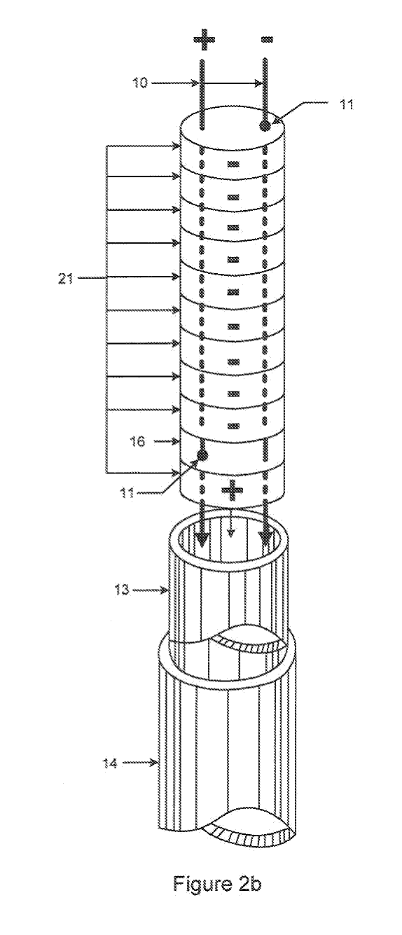

Using the example of a DC driving voltage, a conventional DC power supply comprising a transformer, rectifier and optional parallel capacitor can develop a direct current voltage or potential difference from the domestic mains. The voltage can be coupled to two of the reticulated elements, or between one such element and a casing or other conductive surface that the liquid contacts. The connections can be made in the usual ways that power connections are made, such as by soldering conductors to the element(s) and/or casing or providing an appropriate contact that is resiliently biased against the element or casing. In a DC example, two conductors couple the power supply to electrodes (reticulated elements or other conductors that contact the liquid and are not in direct conductive contact), functioning as an anode and a cathode. Two exemplary configurations are shown in FIGS. 1 and 2.

In embodiments, the applied voltage is about 12-24 volts or less, more preferably about 9 volts or less, with about 7 volts or less particularly preferred. In addition, the applied voltage is preferably at least about 3 volts.

The electrode leads may be made of conventional conductive materials such as stainless steel, copper or aluminum, or may comprise a composite material. By coupling to the power supply at least one reticulated element and at least one other conductor in contact with the liquid, the respective electrodes (10 in figures) are made more disposed to release ions (11 in figures) into the liquid or to accept the deposition of ions, by electrophoresis effects. The potential difference tends to generate a current in the form of ions physically moving between the liquid and one of the anode and the cathode due to electromagnetic forces.

The conductors may be coupled to the elements by soldering or by fasteners (e.g., screws) or simply by contact from resilient pressure. However, the ion exchange activity is such that soldering is preferred. An electrode that releases ions can erode and shrink relative to a simple pressure contact. Also, compounds that are deposited can accumulate and interfere with good conductive connection.

FIG. 1(a) shows one exemplary embodiment of the devices of the invention. Two or more reticulated disc-shaped structures 12 (also referred to herein as “discs”) are placed inside a cylindrical housing 13. In the embodiment shown, four discs are used; however, the number of discs is not critical and can be selected, in part, based on the properties of the liquid to be treated. In the embodiment shown in FIG. 1(a), the discs 12 are not in direct contact with one another but are spaced apart from one another. Spacing is optional, and the size of space between discs may be from about 10 mm to about 3 inches, although a separation about equal to several (2, 3, or 4, preferably 2) disc thicknesses may advantageously be used. If the discs are not spaced apart, a nonconductive panel 16 such as a polymer screen or sieve element may be placed between the discs to prevent shorting of the power supply.

The discs, whether contacting one another or spaced apart, can conveniently be provided in a cartridge as exemplified in the figures by a cylindrical housing 13 into which the discs fit. Generally, the cylindrical housing 13 containing the discs 12 is perforated or slotted, so that the liquid being treated can enter the housing and contact the discs. The housing containing the discs can be packaged (in tube 14) and transported to its point of use. Although the embodiments shown in the figures depict the discs stacked vertically atop one another, any configuration may be used; for example, the discs may be oriented alongside one another, whereby a central axis through the discs would be substantially horizontal. Thus, the orientation in space of the devices of the present invention is generally not critical, although for certain applications a configuration in which, e.g., a liquid to be treated flows upward, may be desirable.

FIG. 1(b) shows an embodiment wherein a number of stacked discs 15 are in direct conductive contact. The discs are coupled to the same potential because they are in conductive contact with one another, and at least one of the discs, and optionally several or all of the discs, are soldered or otherwise connected to a lead from the power supply (not shown).

FIG. 2(a) shows an embodiment wherein most of the discs 20 are positively charged. Such a configuration may be useful for removing negatively charged contaminants from a fluid.

FIG. 2(b) shows an embodiment wherein most of the discs 21 are negatively charged. Such a configuration may be useful for removing positively charged contaminants from a fluid.

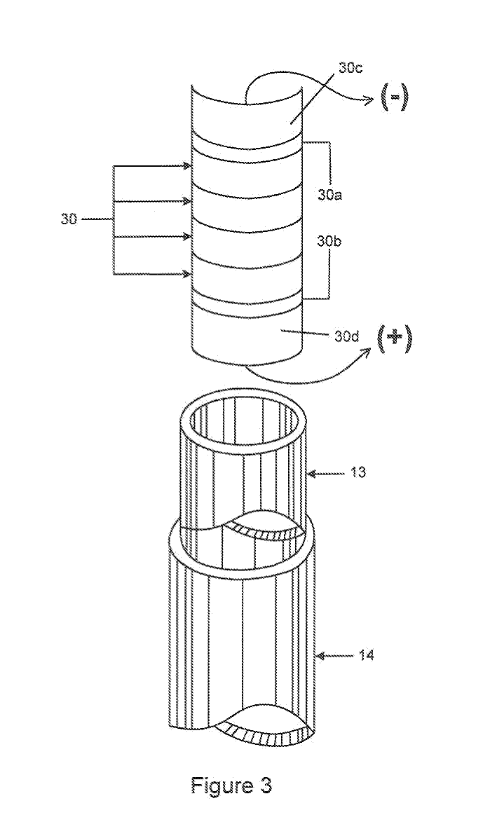

An alternate exemplary embodiment is shown in FIG. 3. In the embodiment shown in FIG. 3, two of the discs (30a and 30b of discs 30) are made of a plastic, i.e. Lexan™ polycarbonate, from General Electric. Other plastic or ceramic materials can be used, provided they are electrically insulating. Exemplary suitable plastic materials for use in the insulating discs include polycarbonate, polyethylene, polypropylene, and polytetrafluoroethylene. In the embodiment shown, one of the plastic discs 30a contacts a negatively-charged reticulated disc 30c, and the second plastic disc 30b contacts a positively charged reticulated disc 30d. One or more additional discs, such as reticulated discs, can be disposed between the two plastic discs, and those reticulated discs will be “unelectrified”, i.e. not coupled to an electrical voltage.

The methods and devices disclosed herein preferably utilize reticulated metal structures. A “reticulated” structure, as used herein, is meant to denote a structure resembling a network of fibers or a mesh-like or sponge-foam like configuration of the metal, in an integral or solid body that defines numerous through passages. Reticulated structures made of brass are described in U.S. Pat. No. 5,788,858. Reticulated structures are desirable for a variety of reasons, including the durability and ease of handling integral discs as opposed to particulates, the inherent electrical connection of all parts of the integral body, the favorable ratio of surface area-to-volume, porosity and/or permeability leading to minimal flow resistance.

Reticulated structures for use according to the present invention preferably have porosities of at least about 85 percent, more preferably at least about 90 percent, even more preferably at least about 95 percent, with a porosity of at least about 97 percent particularly preferred. “Porosity” refers to void volume, i.e., empty volume, within the outer outline of the structure. Pore sizes are preferably at least about 1 micron in diameter, more preferably at least about 2 microns, still more preferably at least about 3 microns, even more preferably at least about 4 microns, and still even more preferably at least about 5 microns. Also preferably, the pore diameters are about 500 microns or less, more preferably about 450 microns or less, still more preferably about 400 microns or less, even more preferably about 350 microns or less, and still even more preferably about 300 microns or less. The term “diameter” as used herein is not intended to imply that pores are necessarily spherical or cylindrical, but rather “diameter” is used to conveniently refer to the dimension in a single pore, measured laterally relative to a longitudinal flow direction. Reticulated structures having pores of highly irregular shapes are within the scope of the present invention, and are preferred because the irregularity further contributes to a high proportionate surface area for exposure to the liquid being treated.

A reticulated structure can be formed from metal particles bound together, such as the foam-like structures shown in U.S. Pat. No. 5,599,456, which is also incorporated herein by reference. Other methods for forming a reticulated structure include melting followed by melt extraction. In an exemplary technique, a molten alloy of three of more metals is extracted, cooled, and solidified into fibers. The fibers preferably have a structure similar to that of a ribbon or tape. The fibers preferably have thicknesses of at least about 15 microns, more preferably at least about 20 microns, still more preferably at least about 25 microns, and even more preferably at least about 30 microns. Also preferably, the fibers are about 3000 microns thick or less, more preferably about 2000 microns thick or less, still more preferably about 1500 microns thick or less, and even more preferably about 1000 microns thick or less. The thicknesses recited herein refer to the thickest part of a fiber. While flat, ribbon-like fibers are preferred, fibers having other structures, including cylindrical or highly irregular shapes, are within the scope of the present invention. The fibers preferably are at least about 0.5 millimeters long, more preferably at least about 1 millimeter long, still more preferably at least about 1.5 millimeters long, and even more preferably at least about 2 millimeters long. Also preferably, the fibers are up to about 100 millimeters, more preferably up to about 75 millimeters, and still more preferably up to about 50 millimeters long. Alternatively, metal substrates can be formed by vacuum compression of metal particles.

In preferred embodiments, the reticulated structures are formed from laminates of the metals. Laminates can be formed by depositing three or more metals onto a substrate having the above-described reticulated structure. Metals can be deposited onto a substrate, for example, by electrodeposition, chemical vapor deposition, physical vapor deposition (sputtering), high energy ion bombardment, plasma implant processes, dip coating, and metallurgical processes known to those skilled in the art.

The substrate can be made of any material to which the desired metals for a device can be adhered. If the substrate is to be removed to leave flow passages, non-metal substrates should be used of a material that can be “burned off”, i.e., decomposed, upon heating to a temperature that is below the melting point of the metal or metals, preferably at temperatures used in forming a laminate on the substrate. Alternatively, it is possible to apply metal to the surfaces of a substrate that is preformed and intended as a permanent support. Exemplary materials suitable as substrates for forming the laminates include polymeric materials such as plastics, wood, carbon, and composite materials, which are subject to heat decomposition. Exemplary composite materials include ceramics and cermets and can comprise one or more compounds such as silica, alumina, and titania. Exemplary plastic and polymeric materials include polyethylene, polypropylene, polystyrene, polycarbonate, polyurethane, copolymers of acrylic and non-acrylic polymers, and blends thereof. Any plastic, polymeric or composite material that can provide a suitable reticulated structure having desired properties of porosity, rigidity and pore size is useful. Plastic and polymeric materials can contain additives and processing aids known to those skilled in the art. Plastic and polymeric materials may contain additives that enhance their physical properties and/or facilitate deposition of a metallic coating thereon.

Following deposition of the metals, if deposition has been accomplished by a method that does not utilize sufficient heat to decompose the substrate, the metals and substrate are heated to a temperature and for a time sufficient to at least partially decompose the substrate, preferably to substantially vaporize the substrate, including any additives and processing aids contained in the substrate. The required temperature and time depend upon the composition of the substrate, and can be determined by one skilled in the art. As an example, for a polyethylene substrate, a temperature of about 1,000 to 2,000 degrees F. is generally adequate.

In some embodiments, the substrate can be metal and can be in forms such as, for example, meshes or wires. Metal substrates will generally not be decomposed, but will remain an integral part of the reticulated structure. Particles of individual metals and/or metal alloys can be deposited onto a metal form of, e.g., copper. Following deposition of the metal or alloy onto the metal substrate, the coated substrate can be annealed, and, if desired, can be further treated. Further treatments can include, for example, high energy ion bombardment, chemical vapor deposition or physical vapor deposition.

The devices and methods of the present invention can be used to treat any liquid, preferably an aqueous liquid, especially water. Preferably, for treatment using the devices and methods of the present invention, a liquid has an ionic impurity concentration of less than about 2000 mg/L, more preferably less than about 1500 mg/L. If necessary, prior to treatment using the devices and methods of the present invention, the ionic impurity concentration of a liquid can be reduced using conventional methods known to those skilled in the art.

The devices and methods of the present invention can reduce the apparent hardness of a liquid, particularly that of water. By “apparent hardness” it is meant coagulation or deposition of ions, which can lead to scale formation. When the apparent hardness of a liquid is reduced, although the concentration of ions in the liquid remains the same, deposition and scale formation is reduced. Thus, the liquid may have a concentration of ionic material that would cause it to be termed “hard”, but has a reduced apparent hardness.

The devices and methods of the present invention can be used in combination with other purification techniques, such as reverse osmosis. Preferably, a liquid purified by a device of the present invention is subjected to further purification, such as reverse osmosis, after having been contacted with the device. The use of the devices of the present invention to treat a liquid prior to subjecting the liquid to reverse osmosis reduces biological contamination of membranes used in subsequent filtration or reverse osmosis. The metal reticulated structure of the devices of the invention also reduces or removes chlorine present in chlorine-treated or contaminated water, reducing damage to membranes used in filtration or reverse osmosis. In addition to or in place of subsequent treatment, a liquid can be treated using one or more conventional treatment methods prior to subjecting the liquid to treatment using the devices and methods of the present invention. For some applications, the devices disclosed herein may be used in combination with modular and mobile water purification plants such as the reverse osmosis water purification unit (acronym: “ROWPU”) that is employed for delivery of potable water or to treat gray water before discharge into the environment.

While the present invention has been described with respect to particular embodiments thereof, it is apparent that numerous other forms and modifications of the invention will be obvious to those skilled in the art. The appended claims and this invention generally should be construed to cover all such obvious forms and modifications, which are within the true spirit and scope of the present invention.

What is claimed is:

1. A device for removing biological materials from liquids to produce process and potable water, said device comprising at least three metals, said metals having reticulated disc-shaped structures stacked in a non-alternating arrangement, wherein said reticulated structures are coupled to an electrical driving signal for ion exchange, electron transfer or electro-catalysis to remove said biological materials from said liquids.

2. The device as recited in claim 1, wherein the metals are in the form of an alloy.

3. The device as recited in claim 1, wherein the electrical driving signal is an alternating current or a direct current voltage source.

4. The device of claim 1, further comprising a substrate having said reticulated structures, wherein said metals are disposed upon said substrate.

5. The device of claim 4 wherein said substrate comprises a non-metallic material.

6. The device of claim 5 wherein said substrate comprises a material selected from the group consisting of ceramics, polymers and composite materials.

7. The device of claim 4, wherein said substrate comprises a metal.

8. The device of claim 1 wherein at least two of said metals are selected from the group consisting of copper, gold, platinum, magnesium, aluminum, activated alumina, zinc, tin, titanium, silver and palladium.

9. The device of claim 1 wherein said metals comprise copper, zinc and silver.

10. The device of claim 1, wherein said biological materials are selected from the group consisting of bacteria, protozoans, viruses and algae.

11. A method for removing biological materials from liquids to produce process and potable water, which comprises contacting said liquids with a device containing at least three metals, said metals having reticulated disc-shaped structures stacked in a non-alternating arrangement, wherein said reticulated structures are coupled to an electrical driving signal for ion exchange, electron transfer or electro-catalysis to remove said biological materials from said liquids.

12. The method as recited in claim 11, wherein the metals are in the form of an alloy.

13. The method as recited in claim 11, wherein the electrical driving signal is an alternating current or a direct current voltage source.

14. The method of claim 11, further comprising a substrate having said reticulated structures, wherein said metals are disposed upon said substrate.

15. The method of claim 14 wherein said substrate comprises a non-metallic material.

16. The method of claim 15 wherein said substrate comprises a material selected from the group consisting of ceramics, polymers and composite materials.

17. The method of claim 14, wherein said substrate comprises a metal.

18. The method of claim 11 wherein at least two of said metals are selected from the group consisting of copper, gold, platinum, magnesium, aluminum, activated alumina, zinc, tin, titanium, silver and palladium.

19. The method of claim 11 wherein said metals comprise copper, zinc and silver.

20. The method of claim 11, wherein said biological materials are selected from the group consisting of bacteria, protozoans, viruses and algae.
